(19) United States
(12) Patent Application Publication
(10) Pub. No.: US 2013/0117300 A1
(43) Pub. Date: May 9, 2013

(54) COLLABORATIVE PATENT REVIEW MONITORING SYSTEM

(71) Applicants: Jitin TALWAR, Panchkula (IN); Sandeep Singh Kohli, Ambala City (IN)

(72) Inventors: Jitin TALWAR, Panchkula (IN); Sandeep Singh Kohli, Ambala City (IN)

(73) Assignee: XLPat TT Consultants Private Limited, Chandigarh (IN)

(21) Appl. No.: 13/615,432

(22) Filed: Sep. 13, 2012

Related U.S. Application Data
(60) Provisional application No. 61/666,961, filed on Jul. 2, 2012.

(30) Foreign Application Priority Data
Sep. 14, 2011 (IN) 2662/DEL/2011

(51) Int. Cl. G06F 17/30

(52) U.S. Cl. CPC G06F 17/30424
USPC 707/769

(57) ABSTRACT

An online automated pre-issuance or post-grant review monitoring system is disclosed, comprising network-accessible collaborative tools through which a company or client that may be interested reviewing a competitor's patent portfolio may order a search vendor or law firm to provide this monitoring and interact among users.

PRIORITY AND CROSS REFERENCE

This application claims the benefit of priority from Indian Provisional Application No. 2662/DEL/2011 filed on Sep. 14, 2011 and U.S. Provisional Application 61/666,961 filed on Jul. 2, 2012, which are incorporated by reference in their entireties.

### SUMMARY OF THE INVENTION

A cloud based system for patent monitoring that collaboratively enables a client to manage, order and search technical information contained in patents, further, once the alert(s) have been generated, online, offline communication between the various users is disclosed.

An exemplary embodiment provides a platform through which user can set patent alerts, set PAIR alerts, order and/or receive notifications on a platform; access parties of interest publicly or privately; add, view, annotate, highlight, collaborate and share information regarding the patents and also online and offline messages with others on the platform. Further, exemplary embodiments provide a transformation of highlights, share and annotations into a portable document format (PDF) document or a similar format document, for example, as originally published by the USPTO or the respective publishing authority as the case may be.

In another exemplary embodiment, in a case where a HTML format or XML readable format or any other markup language or viewing language is available for easy reading and the user or users collaboratively provide for annotation, highlights or mark ups, the said annotations, highlights or mark ups can be correlated to and/or transferred to a PDF document of another similar type of document.

Another exemplary embodiment provides intelligence related to patents and/or published patent applications to users based on the areas of interest. In an exemplary embodiment, the intelligence related to patents can be in the form alerts informing publication of a new patent application or grant of new patent or filing of pre-issuance or post grant opposition or the like. These alerts can be collaboratively shared amongst users or group of users on the network; further, these users can collaboratively highlight, comment and provide mark ups on the shared patents. It is further provided that the patents can be stored in buckets or in personalized folders created by users.

Another exemplary embodiment provides for a separate zone where users can place orders to one or vendors who may be enrolled on to the system.

In another exemplary embodiment, the intelligence will be in the form of an IP newspaper that will provide IP related news. The feeds above can be accessed and users can view the feeds based on their interests and exchange information with each other related to a particular patent in the feed.

Another exemplary embodiment provides a platform for ordering IP related services such as, but not limited to, prior art search, IP licensing services, technology transfer services. The platform will further allow online delivery of IP reports such as, but not limited to, prior art search reports.

Another exemplary embodiment provides a secure and private cloud based network separate instances of the network shall be provided to different user groups with each user group having a private social network and its own privatized web page or privatized and customized Instance wherein the user data is localized.

Another exemplary embodiment provides a computerized system for searching patents and related documents, selecting patents of interest from the list of searched patents, and automatically obtaining a legal document form such as, a Invention Disclosure Statement (IDS), a pre-issuance submission form, or the like, for the selected patents.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made embodiments herein include all such modifications.

### BRIEF DESCRIPTION OF THE DRAWINGS

The accompanying figures are incorporated in, and constitute a part of this specification.

FIG. 1 illustrates a patent monitoring system consisting of remote users linked to each other;

FIG. 2 illustrates a remote query interface using the system shown in FIG.1;

FIG. 3A illustrates a first user interface according to an embodiment of the invention;

FIG. 3B illustrates a second user interface according to an embodiment of the invention;

FIG. 4 provides an exemplary flowchart describing an embodiment of the process for monitoring and reviewing post grant of certain patents or publications;

FIG. 5 illustrates a user terminal according to another embodiment of the invention;

FIG. 6 provides an exemplary flowchart describing an embodiment of the process for automatic generation of an IDS form or a pre-issuance submission form;

FIG. 7 illustrates a query interface and backend databases according to another embodiment of the system;

FIG. 8 illustrates the services provided by the patent monitoring system to the user according to another embodiment of the invention;

FIG. 9 provides an exemplary flowchart describing an embodiment of the process for paid and free alerts in the patent monitoring system;

FIG. 10 illustrates the transformation or shared output from its screen format to an original format as was originally printed by a publishing authority;

FIG. 11A illustrates the annotated data in HTML format; and

FIG. 11B illustrates the transformed annotated data in originally published PDF.

### DETAILED DESCRIPTION

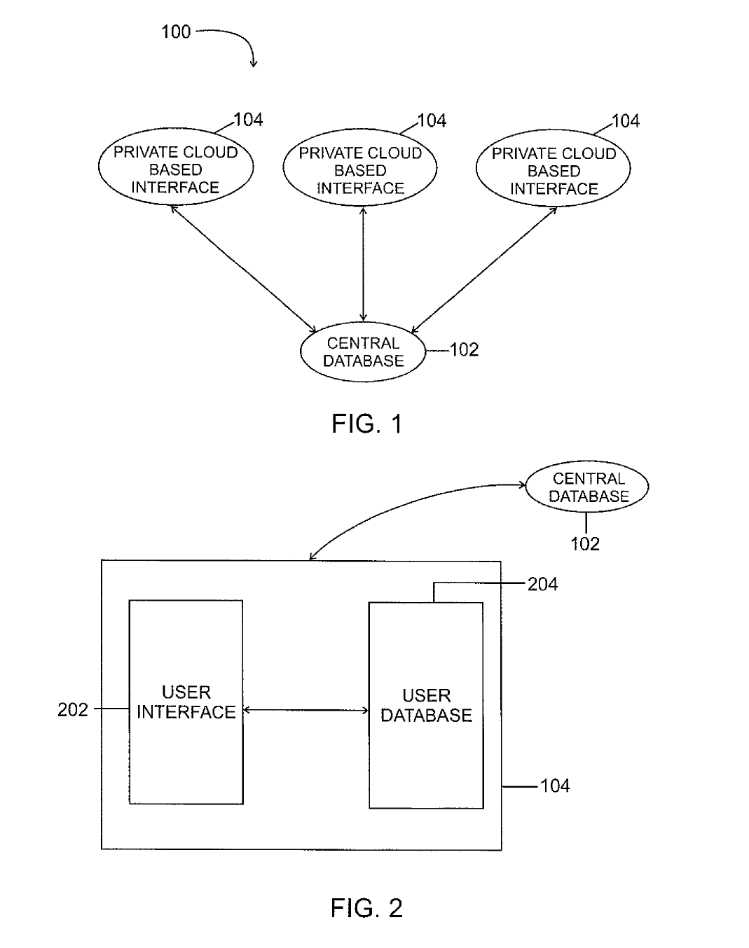

FIG. 1 is a diagram showing an exemplary system 100 used as a patent monitoring system. The system 100 provides a patent search and review platform through which a user can order and/or receive business; access parties of interest publicly or privately; add, view, collaborate and share data with other users. The user can be a client who will generate some task or a service provider who will take action to complete the task. The client can be any one of, but not limited to, companies, inventors, researchers, law firms, licensing firms, universities, paralegals or the like; and the service provider can be any one of, but not limited to, search vendors, advertising firms, law firms, freelancers, researchers, public, or the like.

A user who may be interested in reviewing or keeping a watch on a competitor's patent portfolio or a patent portfolio related to a particular technology or any other information related to patents and/or published patent applications may order a “service provider” to provide this monitoring based on an online system or can set an alert using the alert interface, the alert interface will provide regular updates that will be integrated in the various buckets that are shared amongst various users that the user intends to share the alerts with.

As shown in FIG.1, block 102 depicts a central database communicating with a plurality of private (or personalized) cloud based interfaces 104. Each private cloud-based interface is installed at a client site and can be personalized as per the requirement and choice of the client.

User data related to private cloud based interface 104 can be stored at the client site or within designated sites at the central database 102. The central database 102 primarily contains data required for the system, such as, but not limited to, patent related data (for example, data from the U.S. Patent and Trademark Office PAIR system), patent documents, metadata related to and/or associated with the patent documents, and the like.

The personalized cloud based interface 104 comprises a user interface 202 and a user database 204 as shown in FIG. 2. The personalized cloud based interface 104 can be remotely installed or placed. The personalized cloud based interface 104 can be placed securely on, for example, a website, a mobile device, a desktop app, a thin client, or the like. The user database 204 may contain user data and can be maintained on the remote location or home location along with database 102. Additionally, personalized cloud based interface 104 may also be connected, placed or embedded on a social network, or a social network site, such as, for example, LinkedIn, Facebook or the like.

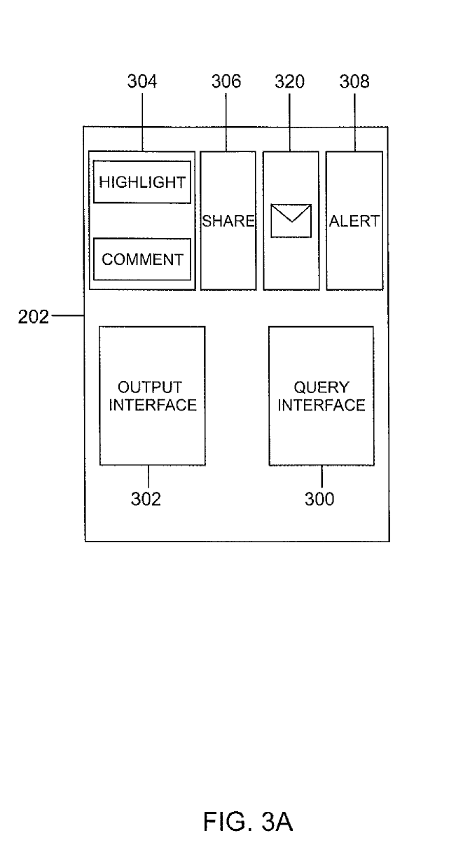

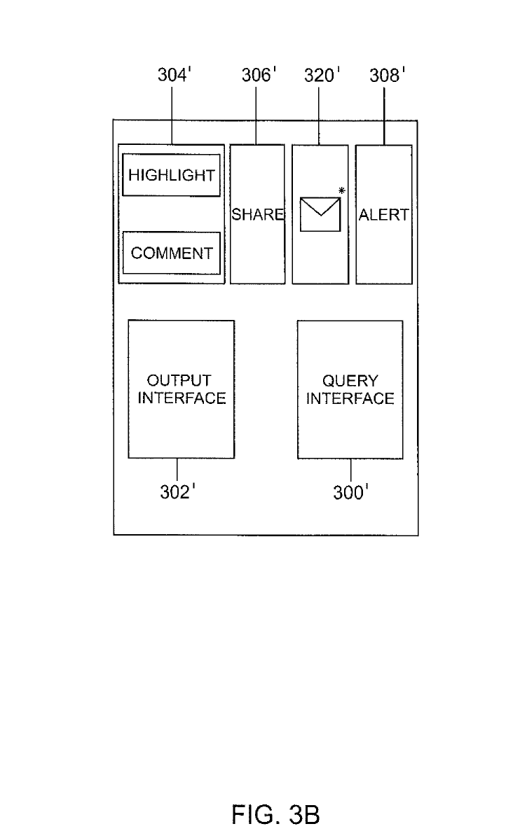

FIG. 3A and FIG. 3B show an exemplary embodiment of the system. FIG. 3A shows a user interface of a first user and FIG. 3B shows a user interface of a second user. The user interfaces illustrated in FIGS. 3A and 3B can be implemented, for example, in a private cloud based interface 104. FIG. 3A and FIG. 3B shows a query interface 300, 300′ for inputting search queries from a user, an output interface 302, 302′ for displaying at least a patent document, an annotation interface 304, 304′ for editing data of the displayed patent documents, a sharing tool 306, 306′ for sharing the patent documents with a second user, an inbox 320, 320′ for notifying another user of the shared patent document, and an alerting interface 308, 308′ for setting alert services for specified patent documents.

With reference to FIG. 3A, the query interface 300 is used to input search queries from a user. The search queries are in the form of a patent search string or the like. Search queries provided to query interface 300 can be sent, for example, to central database 102. The output interface 302 is used for displaying patent documents to the user, for example, patent documents which may be returned in response to a search query. In an exemplary embodiment, the patent documents can be searched from the central database 102 and displayed on the output interface 302. In another exemplary embodiment, the patent documents can be imported or uploaded from an external storages, to be displayed on the output interface 302.

The annotation interface 304 is used for editing data of the patent document displayed at output interface 302. In an exemplary embodiment, the user can highlight some or all displayed data of the patent document. In another embodiment, the user can input annotations, comments, markups, and the like related to the data of the patent document at annotation interface 304. In another embodiment, the user can underline the data of the patent document. In yet another embodiment, the user can collaborate or integrate information with the patent document, such as adding new data, deleting data, or the like.

The sharing tool 306 is used to share the patent documents with /without the annotated/highlighted/marked-up data with any of the plurality of users on the system. For example a first user can view, edit, markup, and/or annotate a patent document at a sharing end user terminal, and can share the patent document with a second user at a shared end user terminal. A user with whom the document is shared will be able to view the document on his/her output interface 302′ in substantially the same format/style as provided by the user sharing the document. Any changes, annotations, markups, etc. made to the data of the patent document at the sharing end user terminal are reflected at the shared end user terminal.

The second user can be notified of the newly shared patent document either through the system using the inbox 320′ of the second user, or through an email or another electronic message.

The alerting interface 308 is used to set automated regular queries on newly published patents and applications. It automatically determines updates or alerts related to the patent document and notify the updates to the users on the system. The updates or alerts can be in the form of, but not limited to, paid alerts, free alerts, promotional alerts or the like.

According to another exemplary embodiment, alerts can also be obtained for certain other types of activity. For example, alerts for post grant review or other forms of third party challenges can be requested and alerts obtained. The system can thus provide intelligence related to patents and/or published applications to clients based on specified areas of interest.

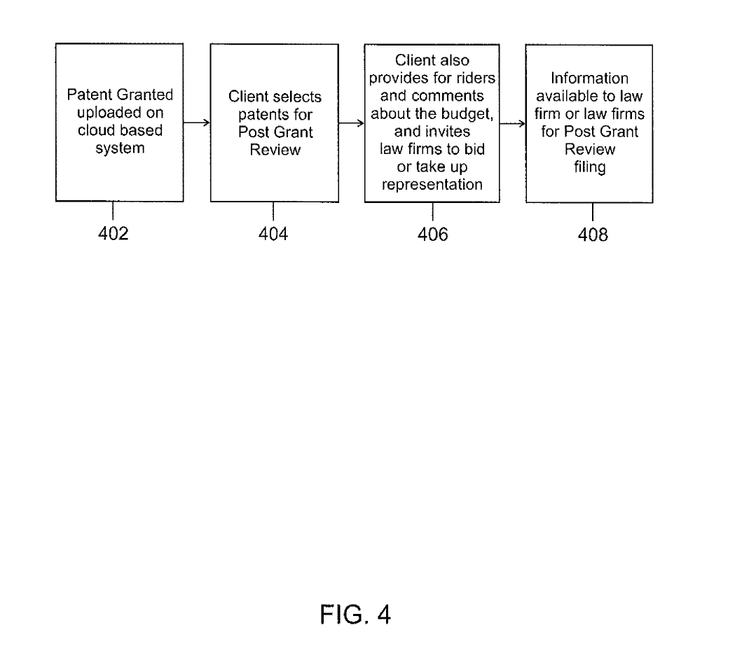

FIG. 4 provides a flowchart describing an embodiment of the process for monitoring and reviewing the post grant of certain patents. In the step 402, the granted patents are uploaded onto a cloud based system, such as but not limited to a website, application on internet, or the like. As one example, the cloud based system can be central database 102, or a storage device in communication with central database 102. In the step 404, a client selects the granted patents for which the client needs post grant review. In the step 406, the client provides for riders and comments about the budget, and invites law firms to bid or take up representation. For example, invitations can be sent, and bids and the like can be received, via inbox 320 or similar functionality. In the step 408, information is made available to law firm for post grant review filing.

In an exemplary embodiment, the intelligence related to patents can be in the form of feeds informing publication of a new patent application or grant of new patent or filing of pre-issuance or post grant opposition or the like.

In another exemplary embodiment, the system will provide feed/alerts in the form of an IP newspaper that will provide IP related news based on interests of the user. It can further provide IP related news based on the technical domain of the user as well as the company with which the user is associated.

This system can provide via an interface (such as output interface 302, alert interface 308, etc.) information of competitors' latest patents and/or published patent applications uploaded on the cloud based system either automatically or through manual classification, the client can login to the system from the user end and review the patents and/or published applications of interest and patents that may have been wrongly granted or qualify for Post Grant Review or pre-issuance opposition.

In another embodiment, a checkout system is proposed wherein the client can indicate companies and technologies that the client is interested in keeping a watch on, can also specify a time period for said watch. For example, the client can provide features, keywords, and/or technologies that the client is interested in, and the system receives this information and can provide the relevant or cached patents to the client on a real time basis or on periodic basis. An alert can be provided to the client, who can then order services including, for example, Attorney review, Pre issuance submissions, search by one or more firms, or the like, using an interface such as interface 320, or using any other means provided in the system.

In another embodiment, the system is hosted on a cloud computing interface or a remote query interface, wherein the client logs in to the interface and makes the choice of competitors that the client wants to watch, the vendor receives this information and thereafter updates the information of patents granted to the said competitor on a real time basis, this information is thereafter used by the client or users to order any of the services and thereafter take an action in case the patent was wrongly granted to the competitor. The users share the output containing patent information and then highlight, annotate and/or comment with selected users who may be sharing the applications.

According to another embodiment, the system enables users over private and public networks to send offline and online messages to each other. The service provider will then receive this information through the system and take further action. Multiple review systems can be created by various service providers for various clients and at the same time, clients can be in touch with various service providers through a single platform and provide conditions for various service providers who may either be on their panel or may be invited to take up representation. Service providers may decide in case they want to or not based upon their acceptance of the conditions.

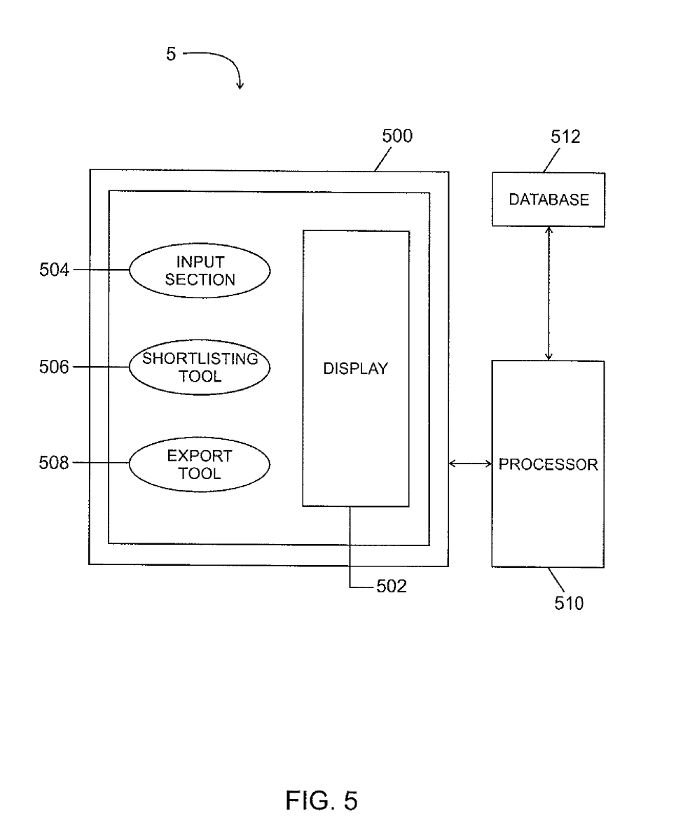

FIG.5 illustrated a user terminal 5 which can either be on a remote cloud query interface or on the network or on a tablet or a mobile application comprising a user interface 500, a processor 510, and a database 512. The user interface 500 further comprises of a display 502, an input section 504, a shortlisting tool 506 to select/shortlist specified results, and an export tool 508 to export the shortlisted patents into a particular form.

The user inputs patent search queries/requests in the input section 504 of the user interface. The processor 510 coupled to the database 512, processes the request/queries of the user and outputs results onto a display 502 of the interface. According to an exemplary embodiment, the queries input by the user are in the form of a search string or any other criteria set by the user. The results are in the form of patents which meet the specified criteria entered by the user.

The shortlisting tool 506 helps the user shortlist specific/required patent(s). The shortlisted patents form a subset of patents which can be put into a patent bucket or any other storage or the like. The shortlisting is done by the user based on any criteria. For example, a user can select a patent containing the word “semiconductor” from the displayed patents on the user interface. The user then put aside the shortlisted patent(s) into a patent bucket for further use.

The export tool 508 enables the user to automatically generate a legal document such as, but not limited to, an invention disclosure statement (IDS) form or a pre issuance submission document or the like for the shortlisted patents. The form is displayed onto the display 502 of the user interface 500, which can be further printed or stored at any suitable place in the user terminal. The automatic generation of the legal document (such as an IDS form) reduces human efforts required in case of manual preparation of an IDS form and the like.

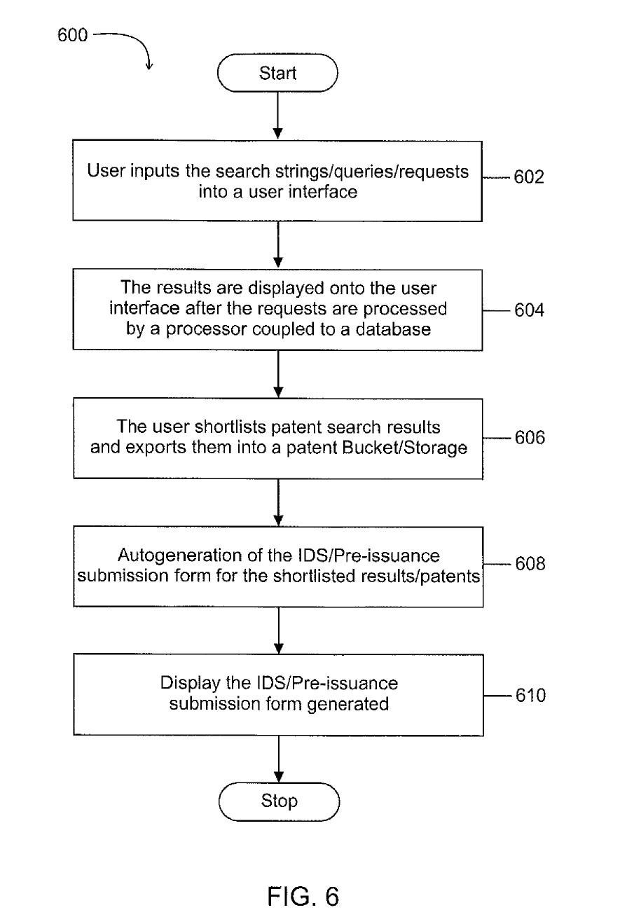

FIG. 6 provides a flowchart 600 describing one embodiment of the process for automatic generation of the IDS form/pre-issuance submission form. In the step 602, a user inputs requests/queries related to patent documents into an input section of a user interface. In the step 604, the processor processes the query or queries input by the user and display results onto display of the user interface. For example, the processor processes a query, accesses the database coupled to the processor (e.g., submits a query to central database 102), and performs the required operations for the generation and display of the results. In the step 606, the user shortlists specified/required patents, and export/accumulates the short listings into a patent bucket or any other storage. One example of shortlisting a patent can be providing an input to a user interface (such as user interface 202) indicating a selection of a patent displayed thereon. Exporting the short listings can include saving an indication of a displayed patent, saving data related to the indicated patent, and saving a copy of the indicated patent. A saved patent can be saved in more than one format, for example, an HTML/XML format and a PDF format, which can be saved as separate data files. In the step 608, the export tool provided on the user interface enables the user to automatically generate IDS form/pre-issuance submission form for the shortlisted patents. In the step 610, the generated form is displayed onto the display of the user interface which can be used for further use.

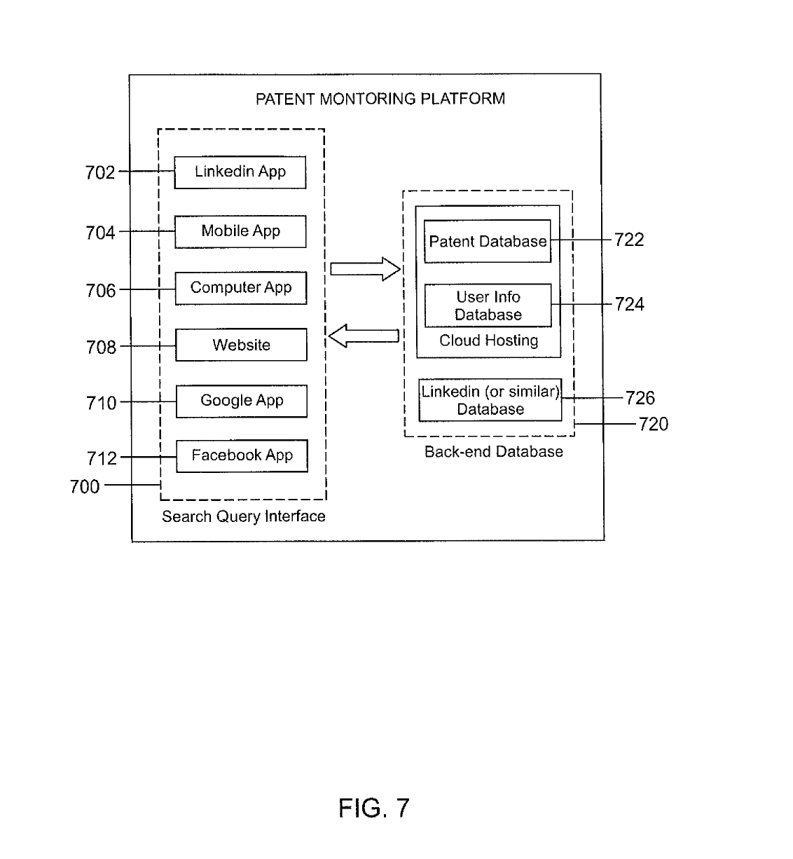

FIG. 7 shows a front end interface or search query interface or remote search query interface 700 and a back end database 720 according to another embodiment of the system. The front end interface can be in the form of, but not limited to, a LinkedIn application 702, a mobile application 704, a computer application 706, a website 708, a Google application 710, a Facebook application 712, or the like. Applications 702 and 712 are examples of applications which are embedded within a computer network-presented service, such as the LinkedIn or Facebook services, or other similar computer network or web-based services. Mobile application 704 is an example of software or similar computer-executable instructions which can be performed on a mobile computing device, including cell phones, smart phones, and other portable computing platforms. Computer application 704 is an example of software or similar computer-executable instructions which can be performed on a desktop or laptop computer, as those devices are generally understood. Website 708 is an example of a computer network-based application or computer network-presented service.

The information related to IP and users of the system will be stored in backend databases. The backend database 720 is in the form of, but not limited to, a patent database 722 or a user info database 724 located at remote location such as a cloud, a LinkedIn database 726, or the like. The frontend interface 700 and backend database 720 communicates with each other through wired or wireless links 730.

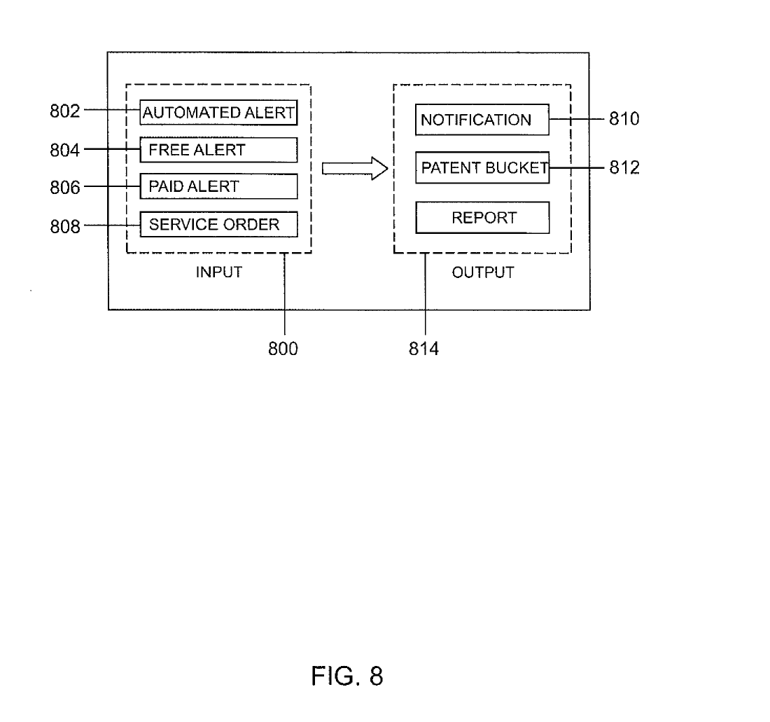

FIG. 8 illustrates exemplary services provided by the patent monitoring system to the user according to another embodiment. The user works on a user terminal. The user inputs a request by a user interface and receives the response on the user interface. The users of the system will have service options 800 available to them on the user interface, for example:

PROMOTIONAL ALERT: This option 802 is for users like service providers to get their existing or potential clients on this system by sending them the automated feeds or alerts based on their area of work or domain of interest. The domain or area of interest can be identified by the service providers based on, for example, previous experience and some R&D. The queries that are needed for generating these promotional alerts can be submitted into the system by the service providers.

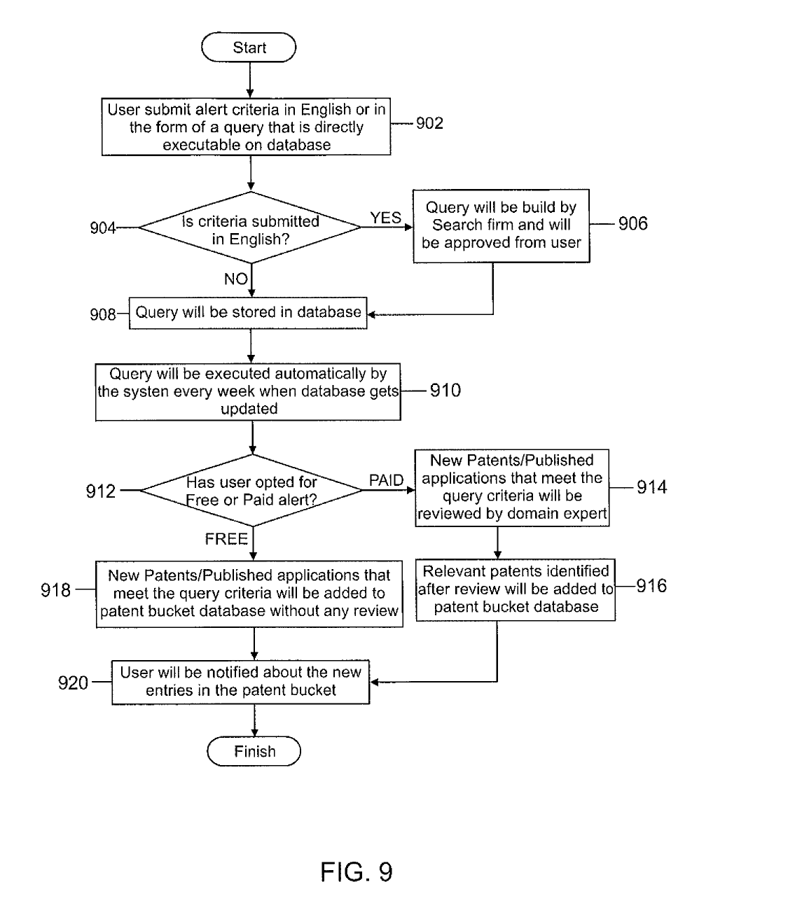

FREE ALERT: The user can add a free alert 804 in the form of search criteria and the system will automatically update patent bucket 812 based for such alerts as soon as some new patent or patent application matching the alert criteria gets published. The user will receive notifications 810 such as, but not limited to, email notifications whenever a new patent is added to the bucket. An exemplary process of a free alert is illustrated in FIG. 9.

PAID ALERT: The user can add a paid alert 806 in simple English. The relevant patents will be updated in the system after review by searching firms/law firms who can understand the requirements in English. The user will receive notifications 810 whenever a new patent is added to the alert. An exemplary process of a paid alert is illustrated in FIG. 9.

SERVICE ORDER: The user can submit service orders 808 on the system such as, but not limited to, prior art search order, IP/technology watch service, patent application tracking service in which any new action/change (such as office action, response to office action, change in patent application or the like) that takes place related to that application will be notified to the user, PAIR alerts (alerts generated when there will be any update in USPTO PAIR), family member alerts (alerts generated when there will be addition/update of any related applications such as, but not limited to, continuation applications, divisional applications, continuation in part applications, INPADOC family members, convention applications) or similar orders. The service orders can be given to any service provider that is listed on the system or to new service providers that are not listed by sending them an invitation to join the system. The system will further have an address book feature where the users can invite their clients via, for example, social media contacts (for example, contacts from service such as LinkedIn) and/or contacts within an email or calendar service (for example, Outlook, Google, etc.). This can permit the building of a network of law firms, companies and search firms on the system.

The alerts can comprise:

Application Alerts: These alerts will be generated when any new action/change/update takes place related to an application being watched. The action can be office action, response to office action, change in patent application or the like,

PAIR alerts: These alerts will be generated when there will be any update in USPTO PAIR in relation to an application being monitored,

Family member alerts: These alerts will be generated when there will be addition, update, opposition or grant of any related applications such as, but not limited to, continuation applications, divisional applications, continuation in part applications, INPADOC family members, convention applications, PCT applications.

Technology Alerts: For tracking developments in a technology domain.

FIG. 9 provides a flowchart 900 describing one embodiment of the process for paid and free alerts in the system. In step 902, the user submits alert criteria, which can be in a natural human language (e.g., English) or in a form of a query that is directly executable on database. In step 904, the system determines if the alert criteria is submitted in English. If the alert criteria is submitted in English, then in the step 906, the query is built by a Search firm and the query is approved by the user, and the flowchart proceeds to the step 908. If the alert criteria are not submitted in English, then in the step 908, the query will be stored in the database of the user terminal. The step 906 can also be set automatically by the user using an alerting interface. Then in the step 910, query will be executed automatically every week when database gets updated. Then in step 912, the system determines if the user has opted for a paid alert or a free alert. If the user has opted for a free alert, then in the step 918, new patents/published applications that meet query criterion will be added to patent bucket database without any review, and the flowchart proceeds to the step 920. If the user has opted for a paid alert, then in step 914, new patents/published applications that meet query criterion will be reviewed by domain expert and then in the step 916 or by the user, relevant patents identified after review will be added to patent bucket database. Thereafter the flowchart proceeds to the step 920. In the step 920, the client or the user will be notified about the new entries in the patent bucket.

In another embodiment, the user sets an automated alert using alerting database and the alerts are run at regular intervals automatically by the system and output is provided on the display to one or more users that are nominated by the user setting the alerts while setting the alert.

The one or many users receive the alerts and these alerts can be viewed on the output interface, shared by users further, annotation interface or the like can also be shared by various users. Users can collaboratively share comments, annotations and highlights and then reach decisions that may be relevant.

This is also helpful in reducing paper trail and increasing collaboration.

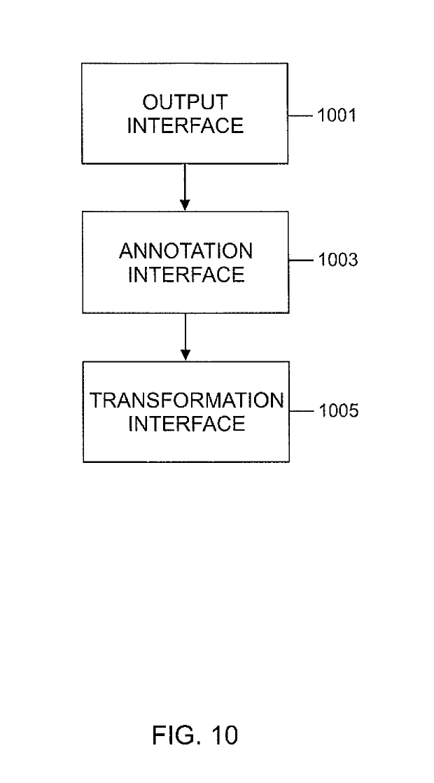

FIG. 10 shows another embodiment of the invention, wherein the system comprises an output interface 1001 for viewing the patent data either uploaded on to the system by user or retrieved through a search query; an annotation interface 1003 for providing markups, annotations and highlighting to the patent data; and a transformation tool 1005 for transforming originally published PDF of a particular patent data to a PDF containing markups, annotations and/or highlighting as may be input in relation to the patent data.

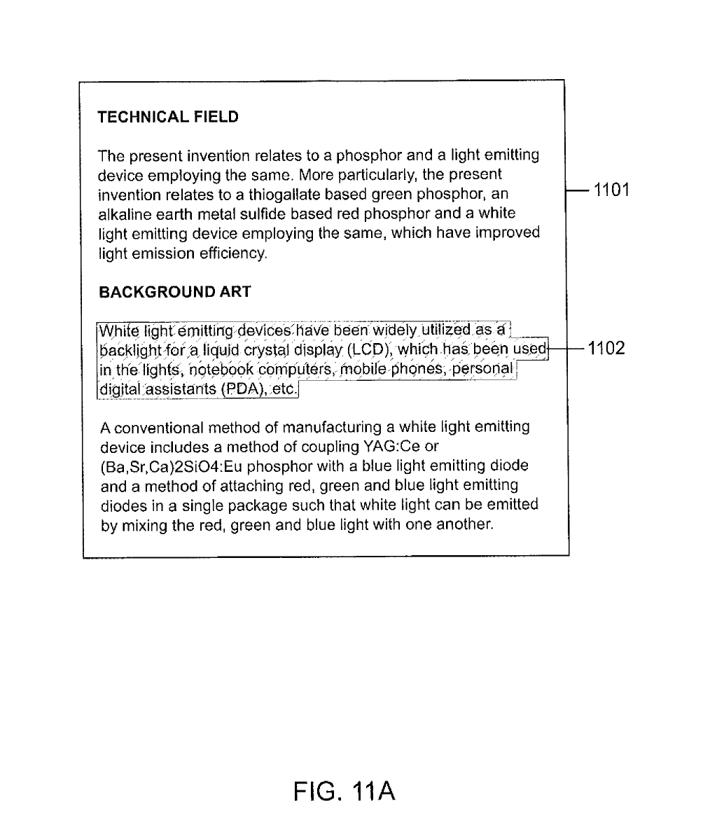

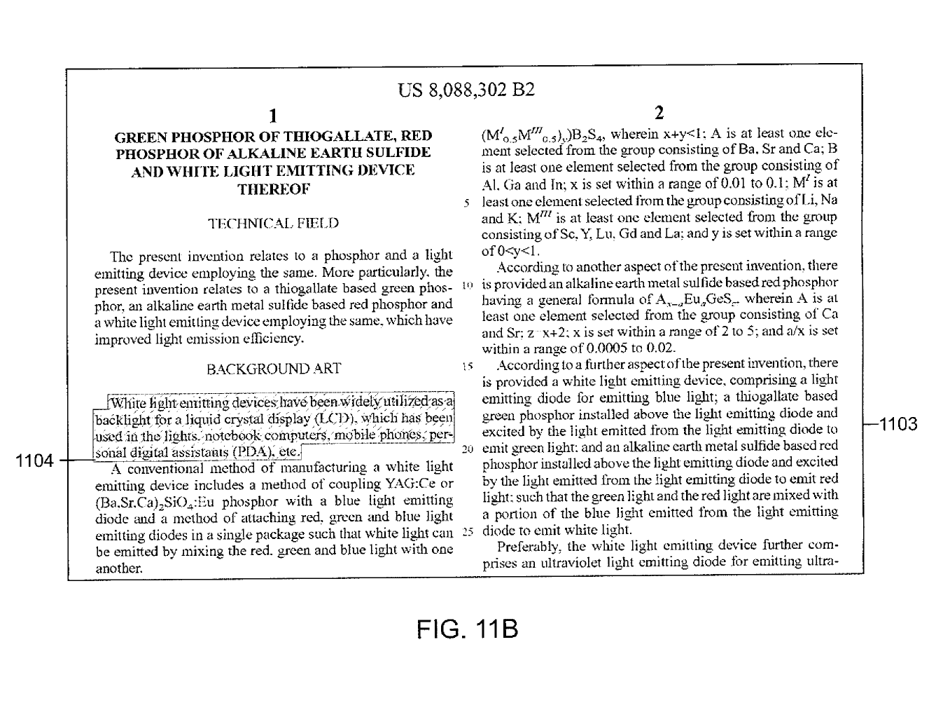

The markups, annotations and/or highlighting 1102 can be done by the user on an displayed page 1101, which can be an HTML document, a web page, an XML document, or any such web document or other display interface as shown in FIG. 11A. The system will then search in a PDF version of the patent document, for example, the originally published PDF for data that corresponds to the annotated/marked-up/highlighted data in the HTML/web page/XML document and determine the start and end coordinates of such lines in the PDF document. In case the system finds the highlighted/annotated/marked-up line more than once in the original PDF, the system will determine the correct line that needs to be highlighted/annotated/marked-up in the PDF document by examining additional information in the HMTL and/or PDF document, for example, paragraphs or lines or sections or headings or the like, that are in close proximity to the highlighted/annotated/marked-up line.

Once the correct start and end coordinates are determined, the changes (highlighting/annotation/markup) made in HTML page are saved (as shown by 1104 in FIG. 11B) in the originally published PDF 1103 of the patent document as shown in FIG. 11B. Thus, the changes made to the patent document in HTML format are retained on the originally published PDF of the patent document, so the user gets the benefit of analyzing and highlighting patent documents in HTML which is more user friendly and easy to analyze and at the same time retain all the changes done in HTML format in the original PDF of the patent document. Examples of originally published publications are publications that are published in PDF or gazette form by official patent and/or government authorities like USPTO, EPO, WIPO or the like. Thus the changes made in the HTML page are reflected upon in the originally published PDF. The transformed PDF or publications can be shared amongst different users on the system and can also be printed by any of them. Originally published PDF's may be stored or fetched as required.

In another exemplary embodiment, the system will be implemented through an application on Social Network like LinkedIn or Facebook. The user will log on to LinkedIn and install an application such as, but not limited to, Patent Monitor on his account. He can list himself as member of a law firm, company or a searching firm. The system will have a database that contains details about most of the famous companies, law firms and searching firms. The user can register himself/herself as working in one of these firms or can list a new firm if it is not available in the database. He can also register himself as a freelancer and list domains of his interest.

As an example of the functionality of the system can be linked through an application such as Patent Monitor. A user can log into his LinkedIn account and uses patent monitor to search for specific type of patents. The user can then order a prior art search on any of the searched patents.

When the user checks out from the selection process, a window (or other notification) can appears where he can see a list of companies that offer the searching services. The user or users who are subscribed to the shared work file can then receive the reports from service provider. Further examples include:

Case 1:

(1) The user can either select from the listed firms or manually add a search firm.

(2) The user then enters the e-mail id of the person, to whom he wants to order the search.

(3) The person with this e-mail id receives an e-mail, inviting him to come on the system. He is also notified about a prospective client willing to order a search.

Case 2:

(1) The system will invite companies and service provider to list themselves on the system, and provide an e-mail id for receiving notifications.

(2) The user can select from these companies as well, while ordering a search, so that the user may not even have to enter an e-mail address for the receiving end.

Case 3: The user can go for a public search, in which the search order will be sent to freelancers and companies, based on their specific interests. These interests are saved when the user is filling his registration details as a freelancer.

Case 4: The user can maintain a list of trusted companies/firms, along with their pricing and can rate them. He can also select firms based on his past experience.

In an exemplary embodiment, the firms will be rated by the users who are actually ordering searches. Based on these ratings the firms will be rated as trusted or inexperienced.

In another exemplary embodiment, the system will have a bidding model, in which the firms/freelancers have already specified their minimum bids. The user can view the available firms/freelancers based on pricing as well. The service provider will then complete the order and submit report either by uploading it on the system or by other known means.

Previous examples are provided to illustrate but not to limit the scope of the claimed inventions. Other variants of the inventions will be readily apparent to those of ordinary skill in the art and encompassed by the appended claims. All publications, patents, patent applications and other references cited herein are hereby incorporated by reference.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present teachings.

Other embodiments of the present teachings will be apparent to those skilled in the art from consideration of the specification and practice of the subject matter disclosed herein. It is intended that the specification and examples be considered as exemplary only, with a true scope and spirit of the disclosure being indicated by the following claims.

What we claim is:

1. A patent sharing and monitoring system comprising:
a database comprising data relating to patents;
a query interface, to receive a query to search the data;
an output interface for displaying an output based on results of a search based on the query, wherein an output can be shared amongst a plurality of users on the patent sharing and monitoring system; and
an annotation interface to receive an annotation to the output, wherein the annotation is shared dynamically amongst at least one of the plurality of users on the system.

2. The system according to claim 1, wherein the query interface, the output interface and the annotation interface are implemented on a mobile device application.

3. The system according to claim 1, wherein the annotation can be transformed into a portable document format document.

4. The system according to claim 1, wherein annotation interface generates an electronic mail message to inform the plurality of users sharing of the annotation.

5. The system according to claim 1, wherein the query interface further comprises:
a personalized cloud based query interface, wherein the personalized query interface receives a query to search the data.

6. The system according to claim 1, further comprising:
an alerting interface, wherein the said alerting interface can be used to set collaborative automated regular queries to alert users about newly published patents and applications;
an output interface for displaying an output, where in the output can be shared amongst various users on the said patent sharing and monitoring system; and
a transformation tool for transforming the output containing the annotation to a portable document format (PDF) document.

7. The system according to claim 6, wherein the output is provided in a form selected from the group consisting of, an Information Disclosure Sheet (IDS) format, and a format provided by the authority to file Pre Issuance Submissions.

8. The system according to claim 6, wherein the output interface shows the output in HTML and transformation tool provides the annotation at the same places on the PDF document.

9. The system according to claim 6, wherein the annotation is transformed on to originally published documents and directly printed out from a printing system.

10. The system according to claim 6, wherein the system is implemented on a mobile device and the transformed original publications are printed through a remote printing system.

11. A cloud based patent sharing and monitoring system comprising:
a database comprising data relating to patents;
a personalized cloud based query interface, to receive a query to search the data;
an output interface for displaying an output based on the query, where in the output is shared amongst various users on the patent sharing and monitoring system;
an annotation tool to receive annotations to the output and to output the annotations amongst the shared users of the system; and
a service provider zone where service providers are enlisted to provide reports on the platform.

12. A computer implemented patent monitoring method, comprising:
accessing a database comprising patent information;
providing a query on a cloud based query interface to search the patent information based on the query;
providing an output on a display based on results of the search and sharing the output amongst multiple users;
receiving an annotation from each of the multiple users and sharing the received annotations among the multiple users; and
transforming the annotated output to transfer the annotations to a portable document format document.
